(19) United States
(12) Patent Application Publication
(10) Pub. No.: US 2011/0024203 A1
(43) Pub. Date: Feb. 3, 2011

(54) MOTOR VEHICLE

(75) Inventors: Robert Fleischhacker, Magstadt (DE); Hagen Deyhle, Weissach (DE); Ralf Goetze, Gifhorn (DE); Holger Gruetzner, Ribbesbuettel (DE); Andreas Voss, Wolferstedt (DE)

Correspondence Address: HESPOS & PORCO LLP, 110 West 40th Street, Suite 2501, NEW YORK, NY, 10018, US

(73) Assignee: DR. ING. H.C.F. PORSCHE AKTIENGESELLSCHAFT, Stuttgart (DE)

(21) Appl. No.: 12/846,977

(22) Filed: Jul. 30, 2010

(30) Foreign Application Priority Data
Jul. 30, 2009 (DE) 10 2009 035 356.9

(51) Int. Cl. B60H 1/32; B60K 25/00

(52) U.S. Cl. 180/53.5; 62/323.3; 62/525

(57) ABSTRACT

A hybrid drive for motor vehicle has at least one combustion engine, an electric machine and an electric energy accumulator (10). The electric energy accumulator (10) is dischargeable by the electric machine during the motor operation and is chargeable by the electric machine during the generator operation thereof. The air conditioning system has at least one compressor (11), a condenser (12) and a main evaporator (13) that provides cooling air (16) to be supplied to a passenger compartment (17) of the motor vehicle. An additional evaporator (18) is connected in parallel to the main evaporator (13) and supplies cooling air (19) to the electric energy accumulator (10) of the hybrid drive.

### CROSS-REFERENCE TO RELATED APPLICATIONS

This application claims priority under 35 USC 119 to German Patent Application No. 10 2009 035 356.9 filed on Jul. 30, 2009, the entire disclosure of which is incorporated herein by reference.

### BACKGROUND OF THE INVENTION

1. Field of the Invention

The invention relates to a motor vehicle with a hybrid drive and an air conditioning system. The invention furthermore relates to an additional evaporator for a motor vehicle of this type.

2. Description of the Related Art

A hybrid drive of a motor vehicle comprises at least one combustion engine, an electric machine and an electric energy accumulator assigned to the electric machine. The electric machine of the hybrid drive can be operated as motor or generator. The electric machine discharges the electric energy accumulator to a greater or lesser extent when whenever an electric machine is operated as a generator. On the other hand, the electric machine charges the electric energy accumulator to a greater or lesser extent when the electric machine is operated as a motor. There have been difficulties to date in cooling the electric energy accumulator of a hybrid drive effectively and reliably with simple means.

An air conditioning system of a motor vehicle comprises at least one compressor, a condenser and an evaporator with an expansion valve positioned between the condenser and the evaporator. A refrigerant circulates in the air conditioning system of a motor vehicle. More particularly, the compressor of the air conditioning system sucks cold, gaseous refrigerant out of the evaporator and compresses the refrigerant. The refrigerant is heated as it is compressed. The compressor presses the refrigerant into the condenser, and the refrigerant is cooled and liquefied in the condenser. The refrigerant passes from the condenser through an expansion valve and into the evaporator where the refrigerant expands and evaporates. Heat is required for the evaporation and is taken from the air flowing through the evaporator. The air is cooled and supplied as cooled air to a passenger compartment of the motor vehicle. Gaseous refrigerant is sucked up again by the compressor from the evaporator and is compressed, thus closing the refrigerant circuit of the air conditioning system. A liquid tank can be positioned between the condenser and the expansion valve. Refrigerant leaving the condenser is collected in the liquid tank before the refrigerant is supplied to the evaporator via the expansion valve.

An object of the present invention is to provide a novel motor vehicle with a hybrid drive and an air conditioning system, in which simple and effective cooling of an electric energy accumulator of the hybrid drive is possible. A further object of the invention is to provide an additional evaporator for a motor vehicle of this type.

### SUMMARY OF THE INVENTION

A motor vehicle according to the invention has a main evaporator that functions to cool the air to be supplied to the passenger compartment of the motor vehicle and an additional evaporator is connected in parallel to the main evaporator. The additional evaporator cools air to be supplied to the electric energy accumulator of the hybrid drive. Thus, the air conditioning system of a motor vehicle with a hybrid drive is used to cool the air to be supplied to the passenger compartment of the motor vehicle and to cool air to be supplied to the electric energy accumulator of the hybrid drive to cool the energy accumulator. This enables effective and reliable cooling of the electric energy accumulator of the hybrid drive with simple means.

The additional evaporator preferably has a housing with an air inlet and an air outlet. Air to be cooled can be supplied via the air inlet to an evaporator unit positioned in the housing. Air cooled by the evaporator unit can be conducted away from the evaporator via the air outlet. A deflecting element is formed in the region of the air outlet of the housing. The deflecting element deflects the cooled air and divides the cooled air into partial air streams. Thus, condensate and moisture do not enter the region of the electric energy accumulator of the hybrid drive that is to be cooled.

Exemplary embodiments of the invention are explained in more detail, without being limited thereto, with reference to the drawings.

### BRIEF DESCRIPTION OF THE DRAWINGS

FIG. 1 is a block circuit diagram of subassemblies of a motor vehicle according to the invention.

FIG. 2 is a first view of an additional evaporator according to the invention.

FIG. 3 is a second view of the additional evaporator according to the invention.

### DETAILED DESCRIPTION OF THE PREFERRED EMBODIMENT

The invention relates to a motor vehicle with a hybrid drive and an air conditioning system. The basic construction of a hybrid drive and of an air conditioning system is well known to a person skilled in the art addressed here.

As noted above, a hybrid drive of a motor vehicle has at least one combustion engine, an electric machine and an electric energy accumulator. The electric machine can be operated as a motor or as a generator. The electric energy accumulator of the hybrid drive is discharged to a greater or lesser extent when the electric machine is operated as a motor and is charged to a greater or lesser extent when the electric machine is operated as a generator. The electric machine provides driving torque to an output of the motor vehicle during the motor operation. On the other hand, a braking torque of the motor vehicle can be converted into electric energy during the generator operation of the electric machine.

The air conditioning system of the motor vehicle functions to cool air to be supplied to the passenger compartment of the motor vehicle and has at least a compressor, a condenser and a main evaporator. The main evaporator cools the air to be supplied to the passenger compartment of the motor vehicle. More particularly, a pressurized liquid refrigerant is expanded and evaporated in the main evaporator and evaporation heat required for this purpose is taken from the air to be supplied to the passenger compartment of the motor vehicle. As a result, the air is cooled.

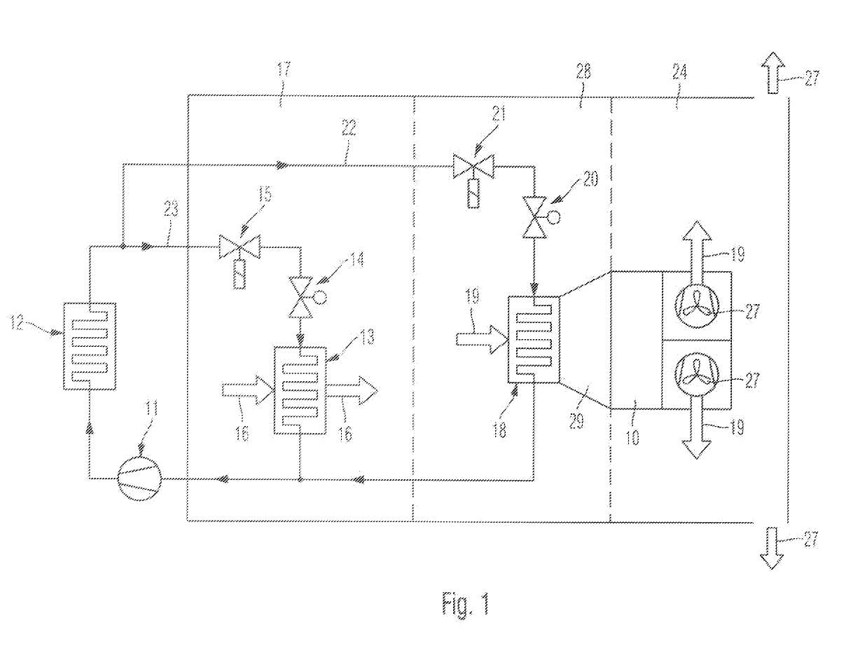

FIG. 1 is a highly schematic block circuit diagram of a motor vehicle according to the invention with a hybrid drive and an air conditioning system. The only part of the hybrid drive of the vehicle that is shown in FIG. 1 is an electric energy accumulator 10. The air conditioning system of the motor vehicle has a compressor 11, a condenser 12, a main evaporator 13, an expansion valve 14 connected between the condenser 12 and the main evaporator 13, and a shut-off valve 15 connected between the expansion valve 14 and the condenser 12. The main evaporator 13 cools an air flow 16 that is supplied to a passenger compartment 17 of the motor vehicle.

The motor vehicle has an additional evaporator 18 that cools an air flow 19 to be supplied to the electric energy accumulator 10. The additional evaporator 18 is connected in parallel to the main evaporator 13.

As shown in FIG. 1, the additional evaporator 18 has an expansion valve 20 and a shut-off valve 21. An additional refrigerant line 22 is disposed to supply refrigerant from the condenser 12 to the additional evaporator 18 and a main refrigerant line is disposed to supply refrigerant from the condenser 12 to the main evaporator 13. The additional refrigerant line 22 branches off from the main refrigerant line 23 upstream of the shut-off valve 15 with respect to the direction of flow of the refrigerant.

The refrigerant circuits are connected in parallel and can be opened and/or closed as required via the shut-off valves 15 and 21 to selectively place the condenser 12 in communication with the main evaporator 13 and/or the additional evaporator 18.

Depending on the open or closed state of the shut-off valve 15 and/or the shut-off valve 21, the compressor 11 sucks up refrigerant that is expanded in the main evaporator 13 and/or in the additional evaporator 18, compresses the refrigerant and supplies the refrigerant to the condenser 12.

The electric energy accumulator 10 of the hybrid drive of the motor vehicle is in a receiving space 24 below the trunk in a rear part of the motor vehicle and is divided off from the actual trunk by a lower trunk panel. In this case, the air flow 19 that is guided via the additional evaporator 18 to cool the electric energy accumulator 10 of the hybrid drive is an air flow that is sucked off from a rear part of the passenger compartment 17.

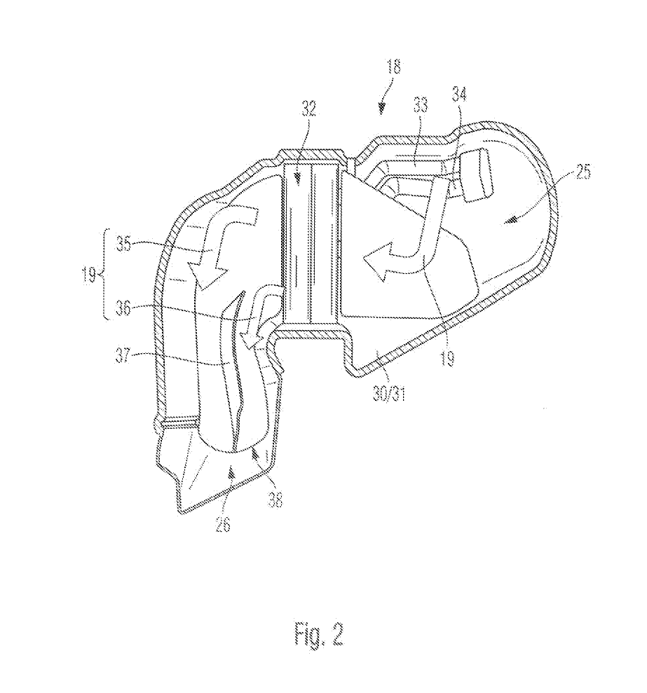

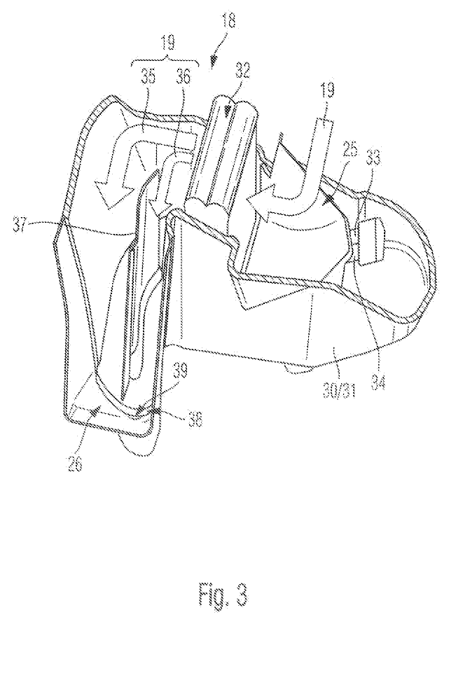

The additional evaporator 18 is shown in greater detail in FIGS. 2 and 3 and has an air inlet 25 and an air outlet 26. The air inlet 25 is positioned in a rear region of the passenger compartment 17 of the motor vehicle and sucks up air from the passenger compartment 17 of the motor vehicle for delivery to the additional evaporator 18. Air cooled by the additional evaporator 18 is supplied via the air outlet 26 to the electric energy accumulator 10 of the hybrid drive.

At least one fan 27 sucks up the air flow 19 that is intended to be guided via the additional evaporator 18. FIG. 1 shows two fans 27 assigned to the electric energy accumulator 10 at positions downstream of an air outlet of the electric energy accumulator 10. Air cooled in the additional evaporator 18 is supplied to the electric energy accumulator 10 via air inlet openings and leaves the electric energy accumulator 10 via air outlet openings.

The fans 27 suck air to be guided through the electric energy accumulator 10 via the additional evaporator 18 and the electric energy accumulator 10. Thus, the additional evaporator 18 does not have a separate fan.

Positioning each fan 27 downstream of the air outlet openings of the electric energy accumulator 10 advantageously enables each fan 27 to be relatively small and quiet.

The fans 27 are arranged with the electric energy accumulator 10 in the receiving space 24 below the trunk in the rear part of the motor vehicle. Accordingly, air sucked up by each fan 27 to cool the electric energy accumulator 10 of the hybrid drive circulates in the receiving space 24 and in the trunk positioned above the receiving space 24. The receiving space 24 and the trunk are vented forcibly via side walls of a motor vehicle body in the direction of the arrows 27. Therefore, air conducted via the electric energy accumulator 10 does not pass back into the passenger compartment 17 of the motor vehicle.

Depending on the location of the additional evaporator 18 in the rear part of the motor vehicle, each fan assigned to the additional evaporator 18 can be positioned downstream of the additional evaporator 18, but upstream of the electric energy accumulator 10 with respect to the direction of flow of the air flow 19. However, the illustrated arrangement with each fan downstream of the electric energy accumulator 10 is preferred.

In the illustrated embodiment, the electric energy accumulator 10 of the hybrid drive is in a rear part of a motor vehicle and is cooled by an air flow 19 guided through an additional evaporator 18 connected in parallel to a main evaporator 13 for cooling an air flow 16 to the passenger compartment 17 of the motor vehicle. Accordingly, air cooling of the electric energy accumulator 10 of the hybrid drive is established with the use of the additional evaporator 18 that is connected via a branch to existing subassemblies of the air conditioning system of the motor vehicle. The air flow 19 cooled in the additional evaporator 18 is sucked up from a rear part of the passenger compartment 17 after cooling and is guided via the electric energy accumulator 10. The cooled air flow 19 enters via air inlet openings into the electric energy accumulator 10 and exits therefrom via air outlet openings.

The energy accumulator is of substantially airtight design apart from the air inlet openings and air outlet openings through which the air flow 19 is guided via the electric energy accumulator 10.

The additional evaporator 18 preferably does not have a separate ventilator or fan. Rather, at least one fan 27 preferably is downstream of the electric energy accumulator 10, as seen in the direction of the air flow 19. Each fan 27 is arranged with the electric energy accumulator 10 in the receiving space 24 below the motor vehicle trunk and is delimited from the trunk by a lower trunk panel.

The additional evaporator 18 preferably is not in the receiving space 24, but rather is in another region 28 of a rear part of the motor vehicle, e.g. in a trunk region delimited by a lateral trunk panel. Thus, the air flow 19 that is cooled in the additional evaporator 18 then can be supplied to the electric energy accumulator 10 via an air-conducting means 29.

The air inlet 25 and outlet 26 of the additional evaporator 18 are defined by a housing 30 of the additional evaporator 18, as shown in FIGS. 2 and 3. Only a lower part 31 of the housing 30 is visible in FIGS. 2 and 3. An upper part of the housing 30 has been lifted off the lower part 31 and is not shown in FIGS. 2 and 3.

The housing 30 of the additional evaporator 18 accommodates an evaporator unit 32. Refrigerant can be supplied to the evaporator unit 32 via a refrigerant inflow 33 and can be removed from said evaporator unit 32 via a refrigerant drain 34. The refrigerant inflow 33 is connected to the refrigerant line 22 shown in FIG. 1. The refrigerant drain 34 is connected to the refrigerant line leading to the compressor 11.

The housing 30 is configured to ensure that condensate and therefore moisture do not pass into the region of the electric energy accumulator 10 via the air flow 19, which is cooled in the region of the additional evaporator 18. More particularly, the housing 30 of the additional evaporator 18 is countered in the region of the air outlet 26 so that the cooled air flow 19 is deflected to a relatively severe extent (e.g. approximately)90° in the region of the air outlet 26 of the housing 30. A deflecting element 37 in the air outlet 26 of the housing 30 then divides the deflected air flow 19 into the partial air streams 35 and 36.

The deflection of the air flow 19 in the region of the air outlet 26 and the division of the air flow into the partial air streams 35, 36 efficiently deposits condensate from the cooled air flow 19.

A rib 38 is formed in the region of the air outlet 26 of the housing 30 downstream of the deflecting element 37 that divides the air flow 19. The rib 38 catches the condensate, and a drain 39 is formed in the region of the rib 38 for removing the condensate. The rib 38 expands a flow cross section in the region of the air outlet 26 in the manner of a step. Thus, the condensate and therefore moisture do not pass via the cooled air flow 19 into the region of the electric energy accumulator 10 of the hybrid drive.

The evaporating unit 32 can be inclined forward by an angle of approximately 20° with respect to the direction of the air flow 19 to prevent deposition of condensate in the region of the air outlet 26 caused by the deflection of the air flow 19 and the division of the air flow into the partial air streams 35 and 36.

What is claimed is:

1. A motor vehicle comprising:
a hybrid drive having at least one combustion engine, an electric machine and an electric energy accumulator, the electric energy accumulator being dischargeable by the electric machine during motor operation of the electric machine and being chargeable by the electric machine during generator operation of the electric machine; and
an air conditioning system having at least one compressor, a condenser, a main evaporator and an additional evaporator, the main evaporator being configured for cooling air to be supplied to a passenger compartment of the motor vehicle, the additional evaporator being connected in parallel to the main evaporator and being configured for cooling air to be supplied to the electric energy accumulator of the hybrid drive.

2. The motor vehicle of claim 1, further comprising:
a main refrigerant line for supplying refrigerant from the condenser to the main evaporator;
an additional refrigerant line branching off from a main refrigerant line for supplying refrigerant from the condenser to the additional evaporator;
a main expansion valve connected in the main refrigerant line between the condenser of the air conditioning system and the main evaporator; and
an additional expansion valve connected in the additional refrigerant line between the condenser of the air conditioning system and the additional evaporator.

3. The motor vehicle of claim 2, further comprising:
a main shut-off valve provided in the main refrigerant line between a branching of said refrigerant lines and the main expansion valve; and
an additional shut-off valve provided in the additional refrigerant line between the branching of said refrigerant lines and the additional expansion valve.

4. The motor vehicle of claim 2, wherein:
the compressor of the air conditioning system sucks up refrigerant that is expanded in the main evaporator and in the additional evaporator, compresses said refrigerant and supplies said refrigerant to the condenser of the air conditioning system.

5. The motor vehicle of claim 4, wherein:
the additional evaporator has an air inlet disposed for sucking air out of the passenger compartment of the motor vehicle and an air outlet via which cooled air sucked out of the passenger compartment of the motor vehicle is removable from said additional evaporator and supplied to the electric energy accumulator of the hybrid drive.

6. The motor vehicle of claim 5, wherein:
the electric energy accumulator of the hybrid drive is positioned below a motor vehicle trunk in a rear part of the motor vehicle; and
the air inlet of the additional evaporator is positioned in a rear region of the passenger compartment of the motor vehicle.

7. The motor vehicle of claim 6, further comprising:
a fan associated with the electric energy accumulator and disposed to suck up air from the passenger compartment of the motor vehicle and to guide said air through the electric energy accumulator of the hybrid drive.

8. The motor vehicle of claim 7, wherein the fan is positioned downstream of the electric energy accumulator.

9. An additional evaporator for an air conditioning system of a motor vehicle with a hybrid drive, the additional evaporator comprising:
a housing;
an evaporator unit in the housing;
an air inlet in the housing and disposed to direct air to be cooled to the evaporator unit;
an air outlet in the housing and disposed to receive cooled air from the evaporator unit; and
a deflecting element formed in the housing in proximity to the air outlet and being configured to deflect the cooled air and to divide the cooled air into partial air streams.

10. The additional evaporator of claim 9, wherein:
the deflecting element deflects the cooled air approximately by 90° and divides the cooled air into two partial air streams.

11. The additional evaporator of claim 10, wherein
a rib is formed in the region of the air outlet of the housing and guides a condensate that forms to a drain.

12. The additional evaporator of claim 10, wherein the evaporator unit is inclined forward, as seen in the direction of flow of the air.
